(19) United States
(12) Patent Application Publication
(10) Pub. No.: US 2006/0289570 A1
(43) Pub. Date: Dec. 28, 2006

(54) Container for holding a product

(76) Inventors: Robert D. Rohr, Laotto, IN (US); Thomas P. Kasting, Fort Wayne, IN (US); John E. Hathaway, Fort Wayne, IN (US); Dale W. Taylor, Hamilton, IN (US); Douglas M. McLelland, Fort Wayne, IN (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/366,685

(22) Filed: Mar. 2, 2006

Related U.S. Application Data
(63) Continuation of application No. 10/419,693, filed on Apr. 21, 2003, now abandoned.
(60) Provisional application No. 60/373,939, filed on Apr. 19, 2002.

(51) Int. Cl. B65D 25/40; B67D 1/16

(52) U.S. Cl. 222/570; 222/109

(57) ABSTRACT

A container for storing and dispensing fluids includes a container body having an upwardly extending annular neck portion defining a container opening and terminating into an annular rim having a generally flat, upwardly facing sealing surface and an inwardly extending flange. A separate spout member includes an annular wall having an inwardly extending portion defining a pour spout and an outwardly extending lip at one end thereof, wherein the lip includes a downwardly facing sealing surface. The annular wall also includes an outwardly extending shoulder below the lip for engaging the rim flange, wherein the annular wall is configured to be received within the container opening and wherein the annular wall shoulder is capable of being snap-fit over the rim flange to create a seal between said rim sealing surface and said lip sealing surface. The container also includes a removable lid that threadedly engages the container neck.

### CROSS-REFERENCE TO RELATED APPLICATIONS

This application is a continuation of U.S. patent application Ser. No. 10/419,693, filed Apr. 21, 2003, which is hereby incorporated by reference and which claims priority from U.S. Provisional Patent Application No. 60/373,939 filed Apr. 19, 2002.

### FIELD OF INVENTION

The present invention relates in general to containers for storing and dispensing various products, and in particular, to portable, hand-held containers for storing and dispensing viscous fluids such as paint, cleaning fluids, laundry products, and beverages, to name a few.

### BACKGROUND

Containers for holding viscous and other fluids are known in the art. Particularly, with respect to the paint industry, nearly all generally one-gallon and smaller paint containers are sold in cylindrical metal cans having an upper edge with a U-shaped channel that accepts the annular protrusion of a high friction metal lid secured by a press fit. This arrangement has numerous operational drawbacks that have not been addressed by the industry.

One such operational drawback is the difficulty in pouring paint from the can into a tray or other paint receptacle. The can lip makes a particularly poor spout. When the paint is poured from the can, paint must be poured across the U-shaped sealing channel on the upper edge of the can. This U-shaped channel inherently retains some of the paint which is discussed in greater detail below. Also, because of the circular shape of the container opening and the U-shaped channel, it is difficult to control the pourability of the paint, thus leading to paint running down the outside of the container. This is especially true when the container is full. This greatly adds to the spilling of sizable quantities of paint.

Further, in using the container itself as a paint receptacle, users often dip paint brushes directly into the container and use the inner edge of the container opening to wipe excess paint from the brush. The circular shape of the can opening is particularly ineffective for wiping a flat brush clean of excess paint. Further, this also causes paint to gather in the annular U-shaped channel.

As paint collects in the U-shaped peripheral channel, resealing the lid becomes particularly messy as the captured paint may splatter when the lid is pounded back onto the can. Further, paint in and around the channel can dry and flake, leading to paint contamination each time the can is jostled. The pounding of the lid can also damage the sealing surfaces, which again can cause the seal to fail. Further, if the paint in the U-shaped channel dries, it may prevent the air-tight seal of the lid and the can and allow the paint therein to dry out or skim over, thus leading to the waste of the remaining paint. After repeated opening, pouring, and closing, the mating surfaces of the can and lid will eventually become fouled leading to the failure of the friction seal. Another drawback for metal paint cans is that while metal cans are coated to prevent rust, this coating often fails, which leads to rust and paint contamination.

Other such drawbacks include the lack of a locking mechanism that would prevent the friction lid from popping off if the can is dropped from a height as little as one meter, with consequent spilling of the contents widely on the ground. The lid, moreover, must be pried off with a tool to gain access to the paint, which proves a problem if no tool is available. The prying action, moreover, often damages the U-shaped channel lid sealing surface.

Another drawback in the construction of such metal paint cans is that the inner lip of the container opening traps paint as it is poured, thereby preventing the user from being able to extract all available paint from the container during pouring or even if a brush is used.

Many efforts have been made to address these and other problems associated with the conventional metal paint can. Some prior art improvements remedy to a degree some of the shortcomings mentioned above, but none, until the present invention, has effectively solved even a majority of these problems.

The present invention, on the other hand, synergistically solves nearly all of the major problems above-enumerated inherent in the conventional metal paint can. The present invention will be more fully described in the following written description with reference to the accompanying drawings.

### BRIEF DESCRIPTION OF THE SEVERAL VIEWS OF THE DRAWING

FIG. 1 is cross-sectional view of the container, the spout, and the lid during disassembly of the invention.

FIG. 2 is a perspective view of the spout of FIG. 1.

FIG. 2A is a top plan view of the spout.

FIG. 3 is side elevational view of the spout.

FIG. 4 is a fragmentary, cross-sectional view of the rim portion of the spout.

FIG. 5 is a cross-sectional view of the sealing means between the lid, the spout, and the container.

FIG. 6 is perspective view of the container lid.

FIG. 7 is a bottom perspective view of the spout.

FIG. 8 is a top plan view of handle component.

FIG. 9 is a magnified portion of the handle component.

### DETAILED DESCRIPTION OF THE INVENTION

Reference is now made to the drawings. Without limiting scope of the present invention, the invention herein is described with regard to its use as a paint container.

However, it is obvious that the improved container of the present invention could be used for holding or dispensing numerous contents including other viscous or powdered products or any product requiring a container for dispensing.

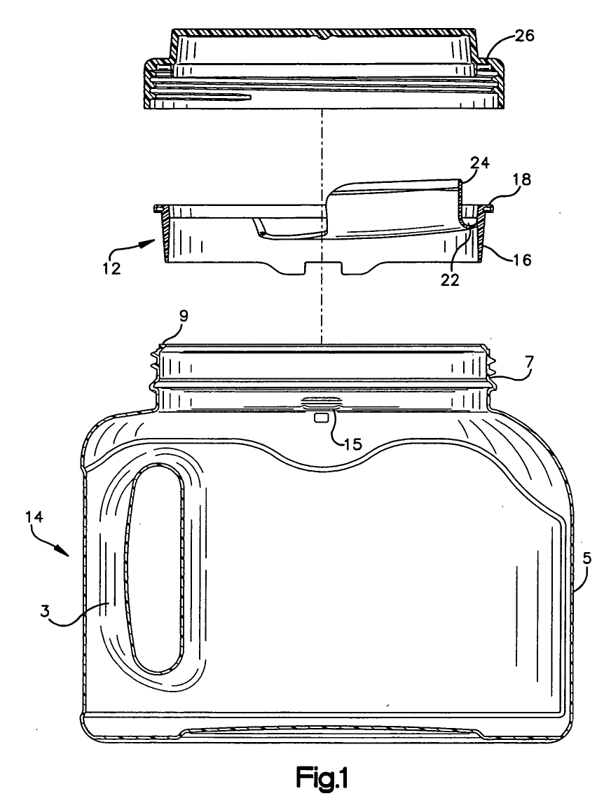

FIG. 1 shows the improved container of this invention used for holding and dispensing paint. As shown in FIG. 1, the improved container comprises a container body 14, a spout member 12, and a lid 10. The body 14, spout member 12, and lid 10 are preferably molded plastic components, although other suitable materials may be used.

However, it is possible to integrally mold the spout member 12 and the container body 14 as one piece. Nevertheless, utilizing a separately molded spout member 12 enables one to utilize the entire opening of the container body when filling the container body and then connecting the spout member 12 to the container body 14 for use.

As shown in FIG. 1, the container 14 includes an integrally molded handle 3, container side walls 5, and an upwardly extending neck portion 7. The upwardly extending neck portion includes means for threadedly engaging a lid. Preferably, the neck includes outwardly extending spiral threads for engaging spiral grooves located in the lid 10. The top portion of the container neck 7 includes a circumferential rim 9 having an upwardly facing sealing surface.

Referring to FIGS. 1 through 4, spout member 12 comprises an annular outer wall 16 having a lip 18 extending radially outwardly past the container rim 9 and nearing the root of the thread. The lip 18 further includes a downwardly extending flange 19 that will run in close proximity to the container wall. Flange 19 is designed such that its outside diameter is coincidental with the inner thread diameter on the neck portion. Thus, the engagement between the spout member 12 and the container produces a flush or nearly flush connection with respect the exterior thereof. As explained below, lip 18 and flange 19 provide a second sealing means to be employed once the lid 10 is securely fitted to the container 14.

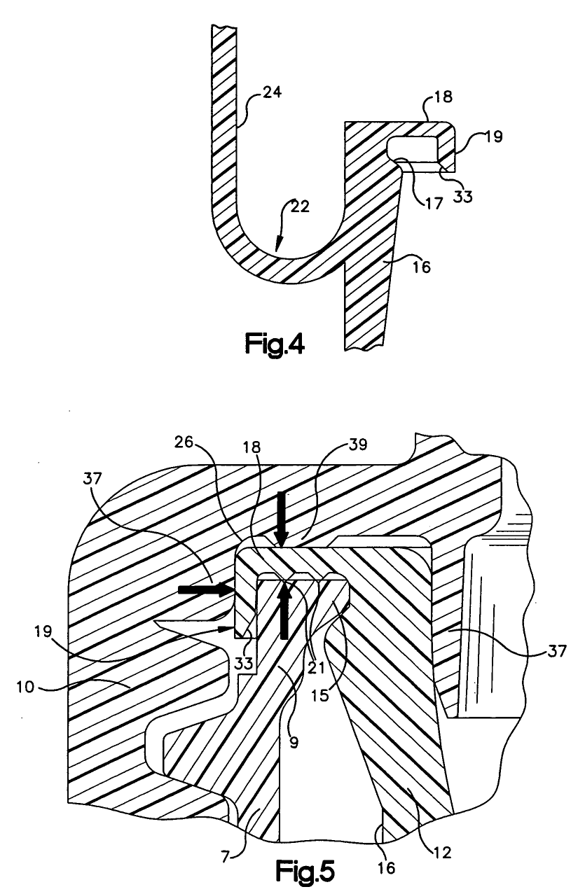

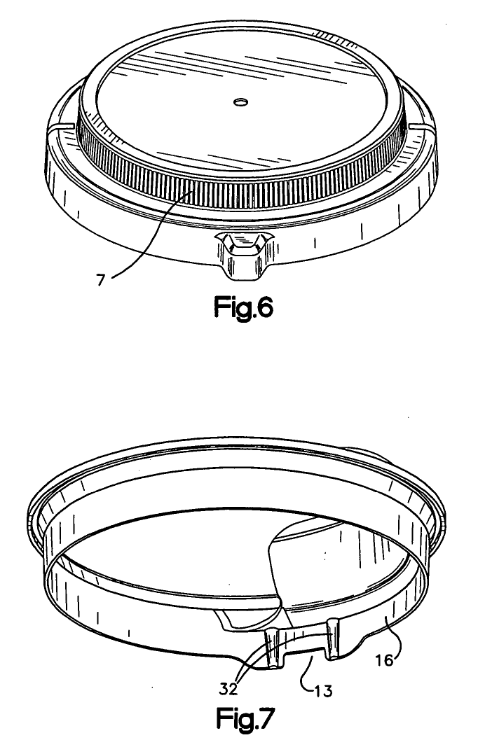

As best shown in FIG. 4, a groove is defined by flange 19, lip 18, and outer wall 16 to permit the receipt of the container rim 9 during engagement between the spout and container. Preferably, outer wall 16 further comprises a shoulder 17 within the groove to permit the snap-fit of the container rim 9 which has a corresponding inwardly extending flange 15. Such a snap-fit construction permits the downwardly-facing sealing surface of the spout member lip 18 to confront the upwardly-facing sealing surface of the rim 9 to creating a liquid-tight seal therebetween. Therefore, upon pouring the contents of the container, the liquid will not escape between the spout member and container sealing surfaces and properly exit the container over spout/paint return structure 20.

The downwardly facing sealing surface located on the underside of the lip 18 may also include a sealing member located within the groove to assist in sealing the spout 12 with respect to the container 14. FIG. 5 shows the lip 18 having at least one annular seal bead 21. While the preferred embodiment utilizes a pair of seal beads, it is clear that any number of seal beads may be used. The seal beads may form part of the sealing system in cooperation with the lid and container opening.

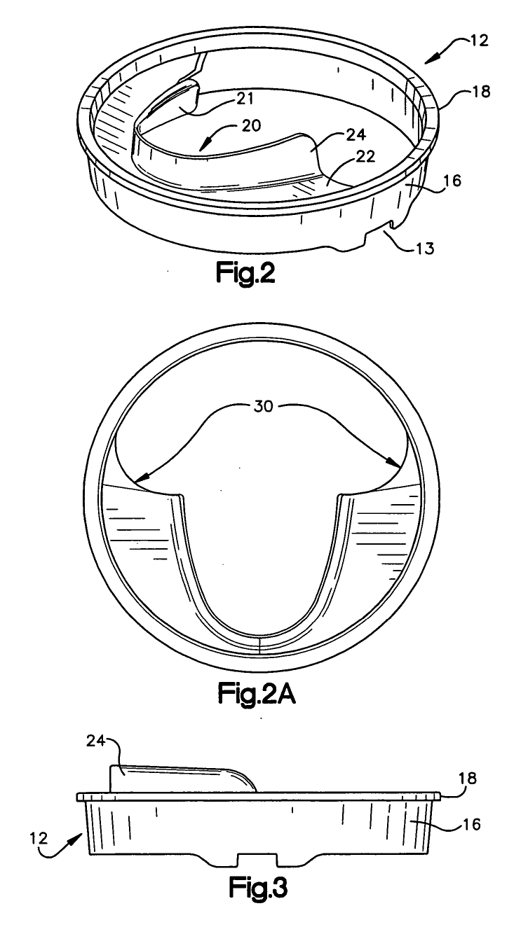

The spout/paint return structure 20, shown best in FIGS. 2, 2A, and 3, comprises a rearwardly sloping trough 22, sloping downwardly from left to right with respect to FIG. 3, which permits paint therein to flow into the container 14 by gravity when the container is in the upright position. Preferably, the trough 22 extends over only a portion of the inner circumference of the spout and only extends partially radially inwardly, such as in the crescent shape shown in the drawings. Extending upwardly from trough 22 is wall 24 which extends above lip 18 to permit the pouring of paint at an angle that prevents paint contact with lip 18 during pouring. The top of wall 24 curves and a downwardly extending wall portion 21 extends through the spout opening. The area located between the front and rear portions of the wall 24 permits paint to gradually gather therein during pouring to create a controlled flow of paint from the container over the front portion of the wall 24.

Spout wall 16 also includes at least one notch 13 formed therein which engages a protrusion 15 extending from the container 14 so as to properly orient the spout 12 with respect to the container 14 and prevent the rotation of the spout 12 when it is set within the container 14. Further as see in FIG. 7, the spout wall 16 is reinforced adjacent notch 13 by at least one stabilizer 32 which provides additional strength to the spout wall 16 to prevent the spout wall 16 from flexing and permitting the spout to easily rotate within the container. Further, spout 12 also includes large radii 30, best shown in FIG. 2A, in the corners of the spout/paint return structure 20 to reduce stress risers in the molded part and provide additional pour control by the end user. Flange 19 may also include another flange 33 which more positively registers the spout into the container opening.

As shown in FIG. 4, the lip 18 of spout 12 is configured to snap-fit with the annular rim 9 of container 14. The assembly is best shown in FIG. 5 wherein outer wall 16 fits within the container opening and lip 18 snap-fits over the annular rim 9 of the container to fix and seal the spout 12 within the container opening. The lid 10 is configured to include a downwardly facing sealing surface 26 which engages the upwardly facing sealing surface of lip 18 to compress lip 18 between the lid sealing surface 26 and the rim sealing surface as the lid threadedly engages the container 14. Lid 10 freely raises above lip 18 when the lid is threadedly disengaged from the container so as not to disrupt the engagement between the spout 12 and the container 14.

The lid 10 also includes a downwardly extending annular plug seal 37. The plug seal 37 slidably engages the inner diameter of the lip 18 of the spout 12 as an alternate seal between the lid 10 and the spout 12. The lid 10 further includes a radial seal shoulder 37 designed to place the outside diameter of the spout 12 under radial compression to improve the seal between the spout/lid and spout/container interfaces. The lid 10 may further include a concentrator step 39 to work in conjunction with the seal beads of the spout. The concentrator focuses axial loading of the lid into the spout seal beads which in turn bear down onto the bottle opening land surface of the rim during threaded engagement between the lid and the container opening. The lid also includes serrations/ribs 7 to the top portion of the lid to provide an improved surface for capping equipment while reducing the visibility of “rubs” or scrapes in the event the capping chucks spin against the lid.

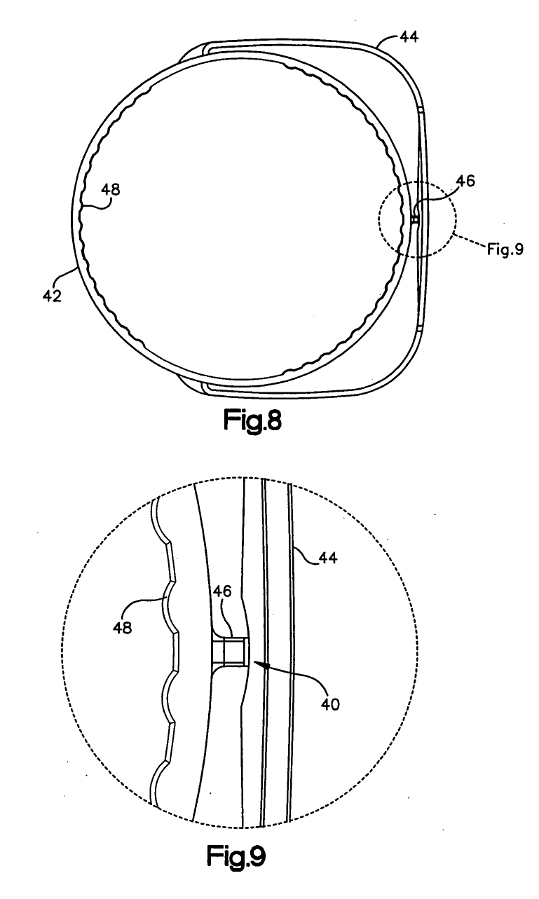

The container assembly may also include a one-piece molded handle, shown in FIG. 8, which can be fitted over the neck of the container opening. The one-piece handle includes an integrally molded handle ring 42 and a handle 44. The handle is molded wherein the handle 44 is attached to the handle ring 42 along a handle retainer portion 46. The handle 44 includes a recess 40 to shroud any “sharps” left after the handle retainer 46 is broken. Such a recess 40 will minimize the possibility of any sharps being felt by the consumer while hand carrying the product. The handle further includes a series of bumps 48 to the inside of the handle ring 42. This provides reduced contact area with the ring's “inside diameter” easing assembly and allowing the consumer to reposition the handle as desired while providing the relationships necessary for proper handle retention on the bottle.

As indicated above, by employing at least one sealing bead located on the downwardly facing sealing surface of the spout member lip, the sealing bead works in combination with a properly placed lid component. When in proper assembly, the spout and lid will be in vertical compression against the rim of the container creating a secure seal to contain the product within the container.

The invention has been described with reference to the preferred embodiment. Obviously, modifications and alternations will occur to others upon a reading and understanding of this specification. The claims as follows are intended to include all modifications and alterations insofar as they come within the scope of the claim or the equivalent thereof.

Having thus described the invention, we claim:

1. A container for storing and dispensing fluids, said container comprising:
a container body defining an interior volume and including an upwardly extending annular neck portion defining a container opening and terminating into an annular rim having a generally flat, upwardly facing sealing surface and an inwardly extending flange;
a separate spout member comprising an annular wall having an inwardly extending portion defining a pour spout and an outwardly extending lip at one end thereof, said lip having a downwardly facing sealing surface, said annular wall having an outwardly extending shoulder below said lip for engaging said rim flange, wherein said annular wall is configured to be received within said container opening and wherein said annular wall shoulder is capable of being snap-fit over said rim flange to create a seal between said rim sealing surface and said lip sealing surface;
wherein the downwardly facing sealing surface comprises at least one downwardly-extending annular sealing bead to enhance sealing engagement with the rim; and
a removable lid having means for engaging said container body.

2. The container of claim 1 wherein said lip further comprises an upwardly facing sealing surface and said lid further comprises a downwardly facing annular sealing surface, wherein upon engagement of said lid and said container body, said lip is compressed between said lid sealing surface and said rim sealing surface to create an air-tight seal therebetween.

3. The container of claim 2 wherein said lid further comprises a downwardly extending seal plug which engages the inner surface of said spout member lip as a secondary seal between said lid and said spout.

4. The container of claim 1 wherein said neck portion further comprises an inwardly extending tab and said spout member annular wall further comprises a notch at its lower end, wherein the engagement of said tab and said notch permits only a single proper orientation of said spout member relative to said container opening.

5. The container of claim 1 further comprising a plastic handle assembly comprising an integrally molded handle and mounting ring wherein said mounting ring can be snap fit over said container neck portion.

6. The container of claim 1 wherein said inwardly extending portion of said spout member defining a pour spout further includes a trough portion sloping rearwardly from said pour spout to provide a drain-back feature where liquid may drain from said spout member into said container body.

7. The container of claim 1 wherein said container does not utilize a separate sealing gasket to create an air-tight seal between said lid and said spout member or said spout member and said container.

8. A container for storing and dispensing fluids, said container comprising:
a plastic container body defining an interior volume and including an upwardly extending annular neck portion defining a container opening and terminating into an annular rim having a generally flat, upwardly facing sealing surface and an inwardly extending flange, said neck portion having outwardly extending spiral threads;
a separate plastic spout member comprising an annular wall having an inwardly extending portion defining a pour spout and an outwardly extending lip at one end thereof, said lip having a downwardly facing sealing surface, said annular wall having an outwardly extending shoulder below said lip for engaging said rim flange, wherein said annular wall is configured to be received within said container opening and wherein said annular wall shoulder is capable of being snap-fit over said rim flange to create a seal between said rim sealing surface and said lip sealing surface;
wherein the downwardly facing sealing surface comprises at least one downwardly-extending annular sealing bead to enhance sealing engagement with the rim; and
a removable plastic lid having spiral grooves for threadedly engaging said container body.

9. The container of claim 8 wherein said lip further comprises an upwardly facing sealing surface and said lid further comprises a downwardly facing annular sealing surface, wherein upon engagement of said lid and said container body, said lip is compressed between said lid sealing surface and said rim sealing surface to create an air-tight seal therebetween.

10. The container of claim 9 wherein said lid further comprises a downwardly extending seal plug which engages the inner surface of said spout member lip as a secondary seal between said lid and said spout.

11. The container of claim 8 wherein said neck portion further comprises an inwardly extending tab and said spout member annular wall further comprises a notch at its lower end, wherein the engagement of said tab and said notch permits only a single proper orientation of said spout member relative to said container opening.

12. The container of claim 8 further comprising a plastic handle assembly comprising an integrally molded handle and mounting ring wherein said mounting ring can be snap fit over said container neck portion.

13. The container of claim 8 wherein said inwardly extending portion of said spout member defining a pour spout further includes a trough portion sloping rearwardly from said pour spout to provide a drain-back feature where liquid may drain from said spout member into said container body.

14. The container of claim 8 wherein said container does not utilize a separate sealing gasket to create an air-tight seal between said lid and said spout member or said spout member and said container.
